(19) United States
(12) Patent Application Publication
(10) Pub. No.: US 2015/0183119 A1
(43) Pub. Date: Jul. 2, 2015

(54) Double Sided Razor and Method of Use

(71) Applicant: Walter Contaldi, Clifton, NJ (US)

(72) Inventor: Walter Contaldi, Clifton, NJ (US)

(21) Appl. No.: 14/638,258

(22) Filed: Mar. 4, 2015

(51) Int. Cl. B26B 21/52; B26B 21/22; B26B 21/40

(52) U.S. Cl. CPC B26B 21/522; B26B 21/4081; B26B 21/527; B26B 21/222

(57) ABSTRACT

A double-ended manual razor is disclosed, with razor on either side of a handle. Each razor is offset from the handle (or offsetable) at an opposite angle, with respect to a midpoint between the two razors, that midpoint also being a highest point of the handle, rising from each razor to a pinnacle in a curvilinear manner. One uses the razor by placing at least one finger on either side of the pinnacle and another under the pinnacle, such as in a concave finger region or circle, and pivots around the middle point, pushing either the one or the other razor downwards onto a surface to be shaved. Then, one switches direction and shaves in the other direction with the other razor, always or sometimes placing more pressure on the side of the device with the razor currently in use to shave or cut.

### FIELD OF THE DISCLOSED TECHNOLOGY

The disclosed technology relates generally to razors, and, more specifically, to double ended razors.

### BACKGROUND OF THE DISCLOSED TECHNOLOGY

Shaving is a chore. Men shave their heads and facial hair. Women shave their legs. In a common method of shaving, one has to take multiple strokes adjacent to each other, moving in the same directions. Razors blades are angled and only work in one direction. Attempts have been made to develop razors that work in both directions, but further development is still needed; nothing has removed the old fashioned razor from its throne, Such a razor, held at an acute angle to the elongated handle remains popular.

U.S. Pat. No. 6,560,876 to Carr discloses a handle with a shaving razor on each of opposite ends of the handle. U.S. Pat. No. 4,461,078 to Carreker discloses a styling razor with two handle portions and razors mounted at the end of each handle portion. U.S. Pat. No. 4,989,328 to Sokoloff discloses a razor with two heads pointed in opposite directions, with a handle extending downwards between each of the razors.

What is needed is a method of more efficiently shaving which lets a person continuously shave with as little interruption or re-positioning of the shaving device as possible.

### SUMMARY OF THE DISCLOSED TECHNOLOGY

A double-bladed razor and it's method of use are disclosed wherein each of two razors are positioned at either side of a handle, the handle having two sides with each side extending at an acute angle, with respect to a plane defined by the working ends of each razor, to a pinnacle positioned at a center point between each razor. The pinnacle defines a top of the device. When using the device, one can place least one finger directly below the pinnacle of the handle (and this finger either being otherwise un-surrounded by the device or surrounded by a portal of the device). Another finger can be placed above a first of the two sides of the device, with yet another finger above a second of the two sides of the device. Additional fingers can be placed in any of these locations. Then, one shaves in a first direction with a first razor while applying pressure with one of the fingers to this razor, and then switches direction of movement while, in some embodiments, keeping the same orientation of the device, and shaves with the second razor, applying pressure there-on with a different finger.

The pinnacle further defines a top of a loop enclosed by the handle, in some embodiments of the disclosed technology. A finger, such as a middle finger, can pass through the loop while shaving in the first direction and/or second direction. This pinnacle can be opposite a dimple (also referred to in the disclosure as “concave region”) on a bottom side of the handle, pressing against this dimple while shaving in any direction, such as the first and second direction referenced above. A line of symmetry can pass through the pinnacle be halfway between each razor (a vertical line of symmetry).

Discussing further the double-sided razor itself, each of two razors are positioned at either side of a handle, in embodiments of the disclosed technology. The handle has two sides each side extended at an acute angle with respect to a plane defined by the working ends (sides used to cut) of each razor. The pinnacle of the handle is positioned at a center point between each razor, the pinnacle defining a top of the device. The handle can have an indentation with a curvilinear surface sized to fit a finger. This indentation can be part of a closed circle. Geometric shapes used in this disclosure can be within 5% (e.g. have a 5% tolerance level) of a true such shape. The indentation can be at a bottom side of the device, beneath the pinnacle and the pinnacle can form part of the indentation (on a top side thereof the material).

Another way to describe the double-ended razor of embodiments of the disclosed technology is that a first razor at a first end and a second razor at a second end define a lower plane. A handle extend between the first razor and the second razor, upwards from the lower plane until reaching a pinnacle. The pinnacle is at a halfway point between the first razor and the second razor and defines an upper plane. A concave region facing towards the lower plane is formed at the halfway point, which can form a line of symmetry, between the first razor and the second razor. The handle can rise curvilinearly from each of the razors towards the pinnacle.

The concave region can be open on the other side of the material forming the concave shape (open to the lower plane) or it can be part of an enclosed circle.

Using the terminology above, the method of use of such a double ended razor is then described as follows. One presses a finger against the concave region, applying greater pressure on an upper side of the handle at the portion which is between the first razor and the pinnacle than between the pinnacle and the second razor when using the first razor. This is reversed when using the second razor. In other words, one then applies greater pressure on an upper side of the handle between the second razor and the pinnacle than between the pinnacle and said first razor when using the second razor.

When applying greater pressure between the first razor and the pinnacle, one can move the entire device in a direction more towards the second razor than the first razor (a first direction). when applying the greater pressure between the second razor and the pinnacle, one can move the razor in a direction more towards the first razor than the second razor (in an “opposite” direction, for example). One can then repeat this in a back and forth motion, alternating between placing greater pressure on one side of the device and then on another side of the device at the same frequency as one alternates between going back and going forth. The finger in the concave region can be used to pivot the razor each time one switches between the “back” and the “forth” direction of motion/each time one changes on which side one applies greater pressure to the handle.

“Substantially” and “substantially shown,” for purposes of this specification, are defined as “at least 90%,” or as otherwise indicated. Any device may “comprise” or “consist of” the devices mentioned there-in, as limited by the claims.

It should be understood that the use of “and/or” is defined inclusively such that the term “a and/or b” should be read to include the sets: “a and b,” “a or b,” “a,” “b.”

### BRIEF DESCRIPTION OF THE DRAWINGS

FIG. 1A shows a perspective view of an arched double-sided razor in an embodiment of the disclosed technology.

FIG. 1B shows a perspective view of a double-sided razor with finger portal in an embodiment of the disclosed technology.

FIG. 2A shows a top and side perspective view of the device shown in FIG. 1A.

FIG. 2B shows a top and side perspective view of the device shown in FIG. 1B.

FIG. 3A shows a bottom view of the device shown in FIG. 1A.

FIG. 3B shows a bottom view of the device shown in FIG. 1B.

FIG. 4A shows a side elevation view of the device shown in FIG. 1A.

FIG. 4B shows a side elevation view of the device shown in FIG. 1B.

FIG. 5 shows a method of using the arched double-sided razor of FIG. 1A.

FIG. 6 shows a method of using the finger portal double-sided razor of FIG. 1B.

FIG. 7 shows shows the embodiment of FIG. 7, moving in the opposite direction.

### DETAILED DESCRIPTION OF EMBODIMENTS OF THE DISCLOSED TECHNOLOGY

Embodiments of the disclosed technology include a double-ended razor/shaver with an arched handle extended there-between. The arch rises at an acute angle with respect to each razor, while each razor is attached at a mirrored angle from one another, with respect to a center point of the device between each razor. At the center point of the device is a pinnacle or raised area, defining an uppermost extremity of the device (where the reverse side of the razors form a lower side thereof). This pinnacle allows a person to place a finger underneath same, and use this finger as a “pivot” point to angle one razor, then the other further downwards. As such, one can shave in a first direction, and then reverse course and shave in an opposite second direction.

It should be understood that “razor” can include any cutting device, and is further used herein, and in the claims, to refer to either a “cutting device” or an “end of a handle where a cutting device attaches.”

Embodiments of the disclosed technology will become clearer in view of the following discussion of the figures.

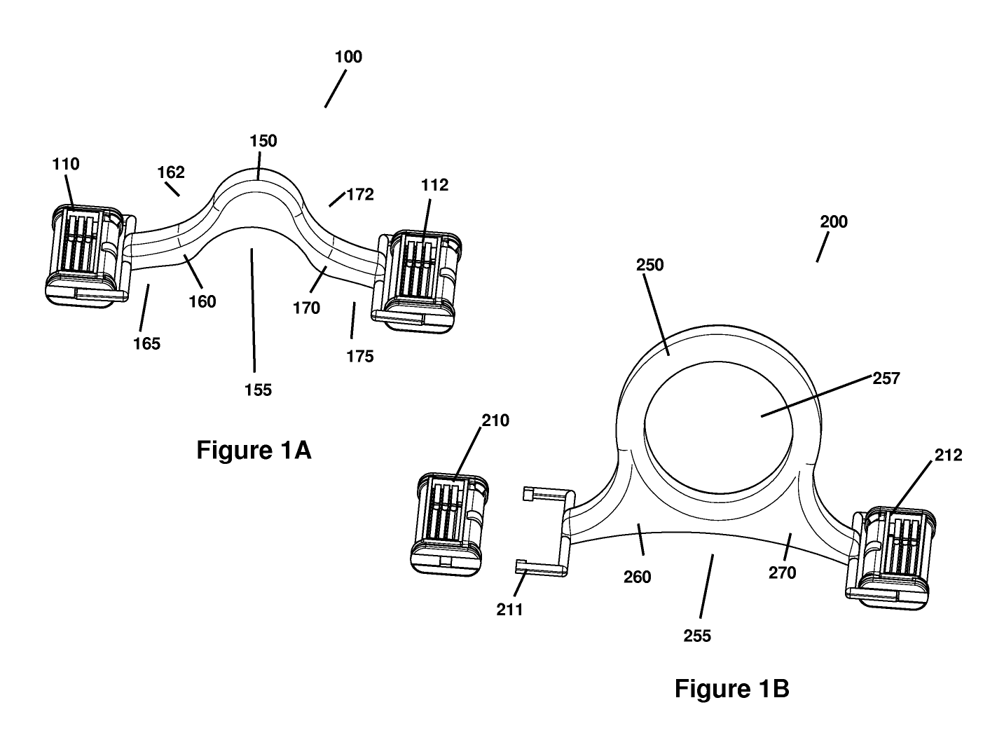

FIG. 1A shows a perspective view of an arched double-sided razor in an embodiment of the disclosed technology. FIG. 1B shows a perspective view of a double-sided razor with finger portal in an embodiment of the disclosed technology. Elements of the arched embodiment are incremented by 100 for analogous or related parts of the finger portal embodiment. Discussing first the arched embodiment 100, two razors 110 and 112 are disposed at opposite ends of the device. The business or working end of each razor points in a mirrored direction, which can include being connected to the handle at a mirrored angle. A “mirrored” angle, for purposes of this disclosure, is one in which has the same number of degrees, in absolute value, off from a vertical access passing perpendicular to the upper most extremity of the device. The “upper” extremity is defined by the arch 150 having a pinnacle in the center of two sides 160 and 170 which angle downwards towards each razor 110 and 112. This pinnacle is also the horizontal center of the device.

Under the arch is a cavity 155 which can be curvilinear, concave, and/or adapted for abutment by a finger such as the middle finger. Beneath the side 160 of the handle is a location 165 for placement of another finger, such as the index finger. Beneath the side 170 of the handle 170 is a location 175 for placement of yet another finger, such as the ring finger. The arch 150 is defined as beginning and ending where the derivative of the slope changes between a razor and pinnacle from a positive to a negative, or negative to a positive, closest to the pinnacle. This is further defined such that the arch 150 ends where the slope of the underside of the handle stops having a greater increase than previously, relative to a line formed from the razor to pinnacle. This is still further defined as an area beneath the handle which is concave; once the underside of the handle becomes convex, it is no longer part of arch 150.

Discussing in greater detail the areas exterior to the handle, above the handle between the arch 150 and razors 110 are two areas 162 and 172, on either side. A finger may be placed in one of these positions and a second finger, in the other position. Below the handle, between the arch 150 and each razor are two lower positions 165 and 175. A finger may be placed in one of these positions and a second finger, in the other position. A finger can also be placed within the concave cavity 155. In any of these cases, the finger rests or applies pressure on the handle extending between the two razors, either on the upper or lower side thereof. As such, greater pressure can be applied to one or the side of the device, against a person.

Referring now to the finger portal embodiment 200 and FIG. 1B, the arch 150 of the prior embodiment is replaced with a finger portal 257. This portal can be circular, oval, ovoid, square, rectangular, or the like. The finger portal 255 is within a closed loop 250 of any shape, in embodiments. This closed loop 250 reaches the pinnacle of the device, again halfway between the razor 210 and 212 and forms a vertical line of symmetry. The handle extends from this closed loop to one side of the handle 260 and the other side of the handle 270 with an area beneath, 255. In use, one places a finger though the finger portal 250 and at least two additional fingers either above and/or below the left portion 260 of the handle and right portion 270 of the handle.

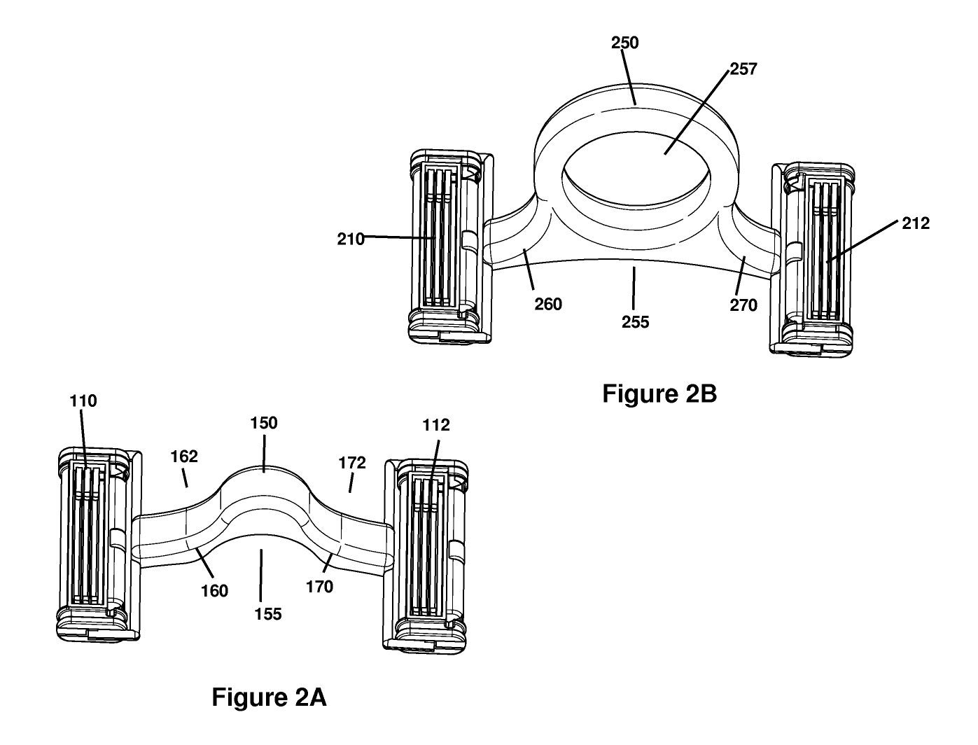

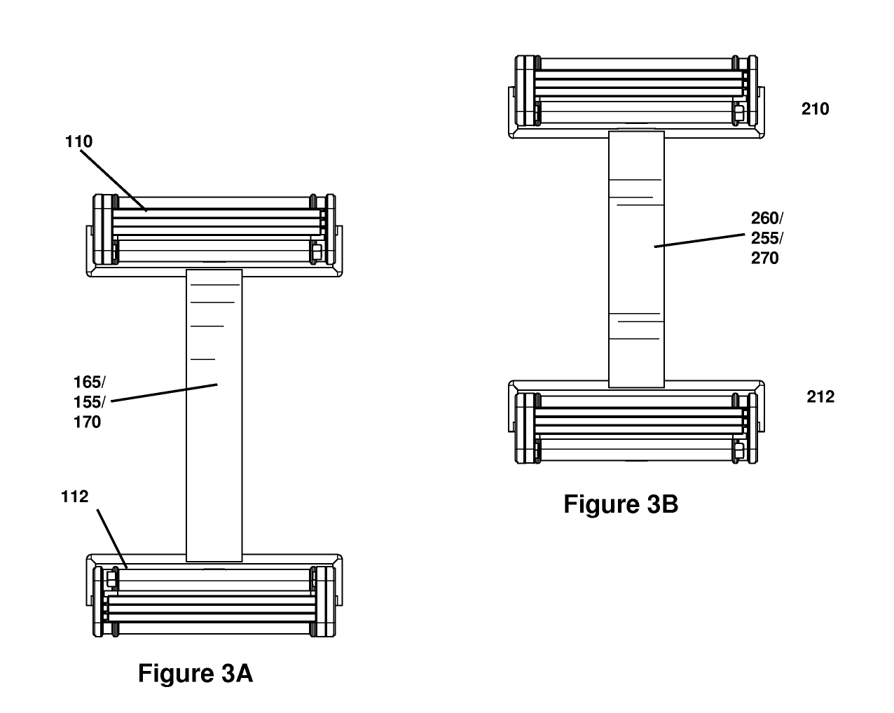

FIG. 2A shows a top and side perspective view of the device shown in FIG. 1A. FIG. 2B shows a top and side perspective view of the device shown in FIG. 1B. FIG. 3A shows a bottom view of the device shown in FIG. 1A. FIG. 3B shows a bottom view of the device shown in FIG. 1B.

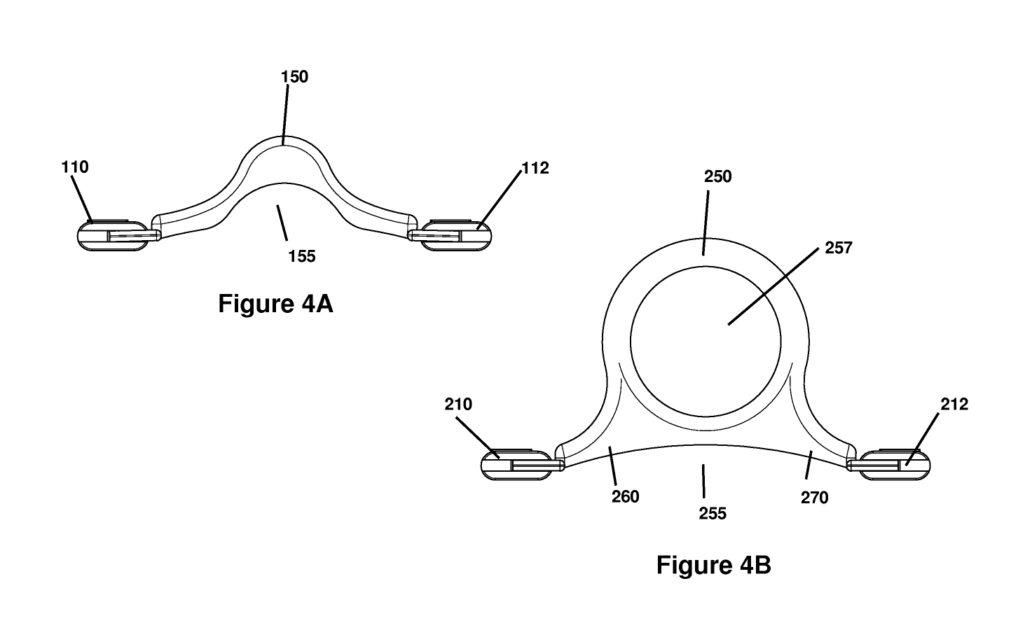

FIG. 4A shows a side elevation view of the device shown in FIG. 1A. FIG. 4B shows a side elevation view of the device shown in FIG. 1B. In an embodiment of the disclosed technology, the dimensions of the elements shown in FIGS. 4A and 4B are precise and can be used to determine actual angles and/or dimensions of such embodiments represented therein.

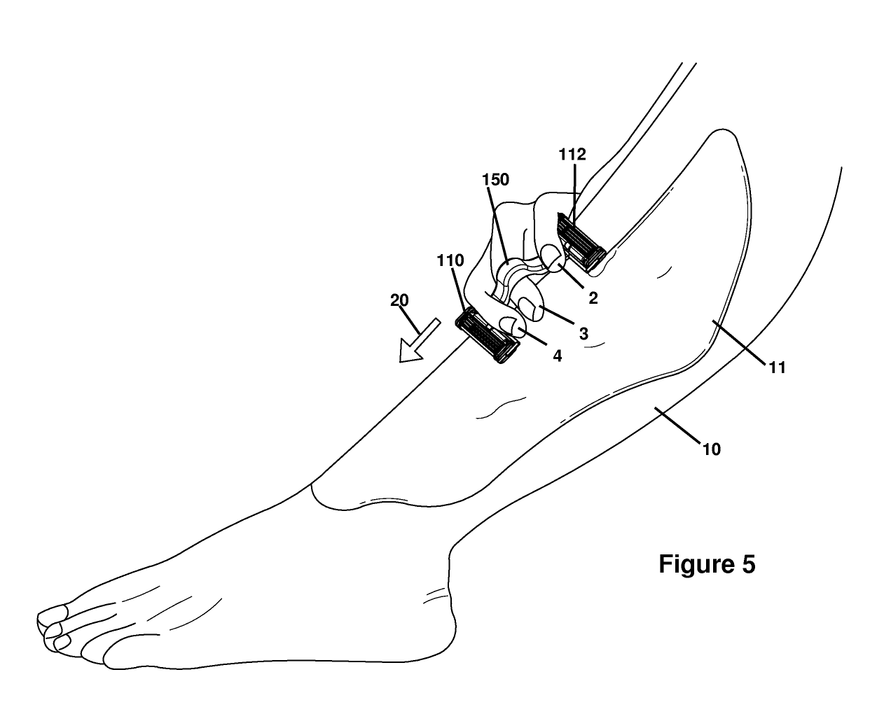

FIG. 5 shows a method of using the arched double-sided razor of FIG. 1A. In the method shown, the razor 100 is placed against a leg 10. The leg 10 has shaving cream 11 there-on. A middle finger 3 is placed below the arch 150, between the leg 10 and the device 100. An index finger 2 is placed above the handle of the device 100 between a razor 112 and the arch 150. A ring finger 4 is placed above the handle of the device 100 between a razor 110 and arch of the device. The device 100 is situated between the leg 10 and the index 2/ring 4 fingers. As shown, the razor 100 is moving in a downwards direction 20, towards the foot. The razor 112 is against the leg 10 and as such, there is greater pressure applied on the handle of the device 100 by the index finger 2 than the ring finger 4. When switching directions and going back upwards, away from the foot, the device remains in the same orientation (razor 112 above the razor 110, relative to the leg, other body part being shaved, and/or relative to the surface of the earth), but moves in a generally or substantially opposite direction with pressure applied being greater from ring finger 4 than index finger 2.

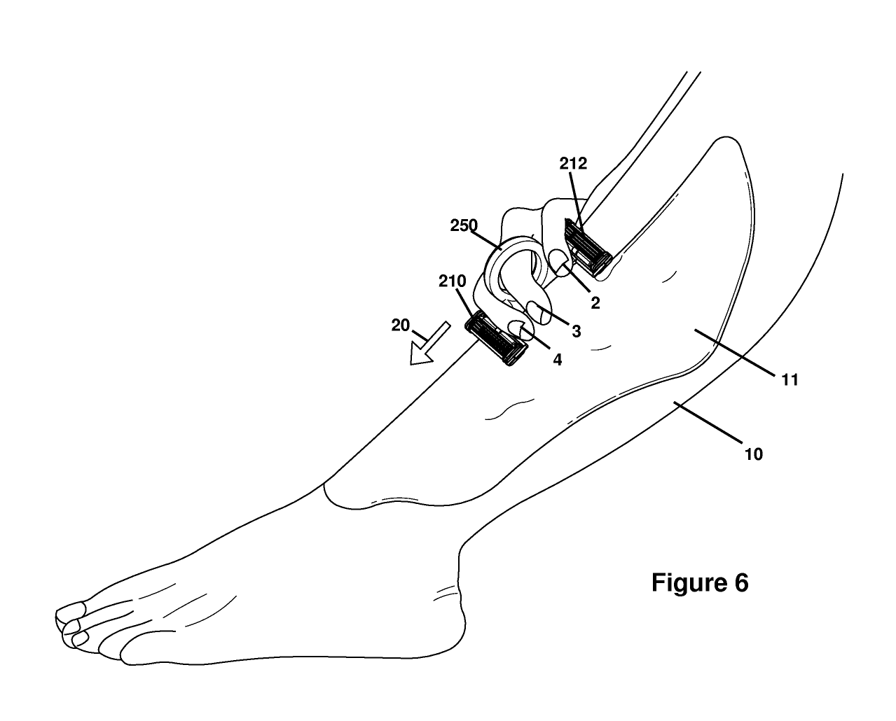

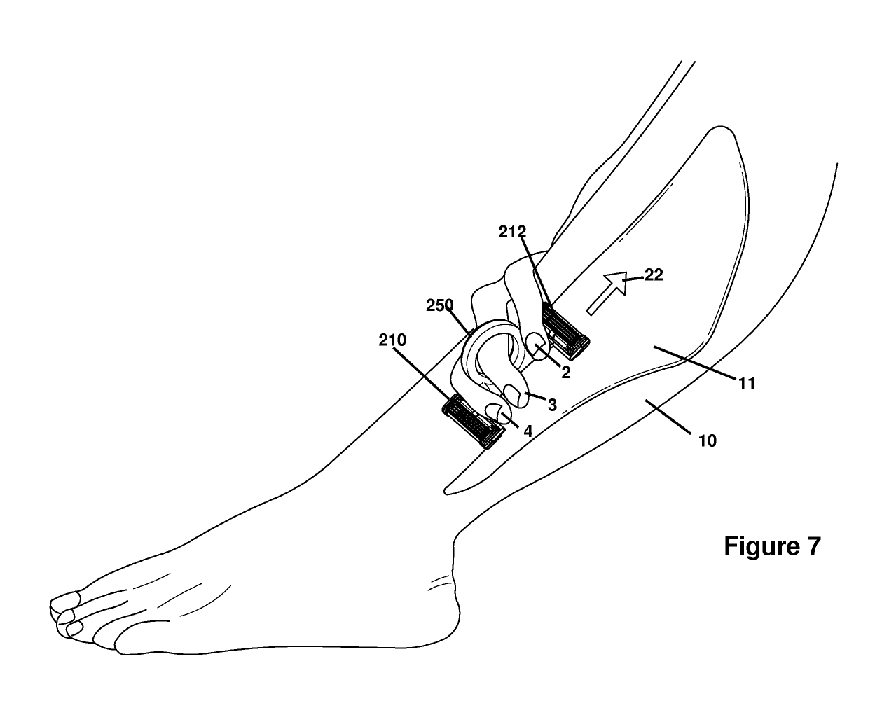

FIG. 6 shows a method of using the finger portal double-sided razor of FIG. 1B. FIG. 7 shows shows the embodiment of FIG. 7, moving in the opposite direction. Here, the finger portal device 200 is shown, first moving in a downward direction 20, and then in an upward direction 22. It can be seen that when finishing in a first direction, then the person reverses direction (defined as 180 degrees and/or within 5, 10, 20, 30, 46, 60, or 90 degrees thereof) and uses the other razor on the double-ended razor device, but keeps the device itself in the same orientation (having a change in direction less than and/or equal to 5, 10, 20, 30, 45, 60, or 90 degrees).

It should be understood that any configuration of the fingers can be used and any body part can be shaved with this method/device. For example, one can place two fingers on each side of the arch/finger portal, two fingers in the portal or under the arch, a finger above and below one side of the handle with another under the arch or in the finger portal, or the like. Any configuration allowing the user to press a razor against an area to be shaved can be used.

Still further, it should be understood that while a leg is shown in the drawings, this device has other applications, such as to shave a head. One can use the above-described methods to go back and forth over a head to shave, alternating which razor is used to shave with each change between the “back” and “forth” direction.

While the disclosed technology has been taught with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the claims are to be embraced within their scope. Combinations of any of the methods and apparatuses described hereinabove are also contemplated and within the scope of the invention.

1. A double-bladed razor method of use, wherein each of two razors are positioned at either side of a handle, said handle comprising two sides with each side extending at an acute angle, with respect to a plane defined by the working ends of each said razor, to a pinnacle positioned at a center point between each said razor, said pinnacle defining a top of said device, the method comprising the steps of:
placing at least a second finger directly below said pinnacle of said handle;
placing at least a first finger above a first of said two sides of said handle;
placing at least a third finger above a second of said two sides of said handle;
shaving in a first direction with a first razor of said two razors while applying pressure on said handle with said first finger;
shaving in a second direction with a second razor of said two razors while applying pressure on said handle with said third finger.

2. The double-bladed razor method of use of claim 1, wherein said pinnacle further defines a top of a loop enclosed by said handle and said second finger passes through said loop while shaving in said first direction and said second direction.

3. The double-bladed razor method of use of claim 1, wherein said pinnacle is opposite a dimple on a bottom side of said handle and said second finger presses against said dimple while shaving in said first direction and said second direction.

4. The double-bladed razor method of use of claim 1, wherein said double-bladed razor has a line of symmetry through said pinnacle and halfway between each said razor.

5. A double-bladed razor comprising:
each of two razors positioned at either side of a handle;
said handle comprising two sides with each side extending at an acute angle, with respect to a plane defined by the working ends of each said razor;
a pinnacle of said handle positioned at a center point between each said razor, said pinnacle defining a top of said device.

6. The double-bladed razor of claim 5, wherein said handle comprises an indentation with curvilinear surface sized to fit a finger.

7. The double-bladed razor of claim 6, wherein said indentation is part of a closed circle.

8. The double-bladed razor of claim 6, wherein said indentation is at a bottom side of said device, beneath said pinnacle; and
said pinnacle forms a part of said indentation.

9. The double-bladed razor of claim 5, wherein said double-bladed razor has a line of symmetry through said pinnacle and halfway between each said razor.

10. A double sided razor, comprising:
a first razor at a first end and a second razor at a second end defining a lower plane;
a handle extending between said first razor and said second razor upwards from said lower plane;
a pinnacle at a halfway point between said first razor and said second razor, defining an upper plane; and
a concave region facing towards said lower plane at said halfway point between said first razor and said second razor;

11. The double sided razor of claim 10, wherein said handle rises curvilinearly from each said first and second razor towards said pinnacle.

12. The double sided razor of claim 11, wherein said halfway point defines a line of symmetry of said double sided razor.

13. The double sided razor of claim 12, wherein said concave region is part of an enclosed circle.

14. The double sided razor of claim 12, wherein said concave region is open to said defined lower plane.

15. A method of using said double sided razor of claim 12, comprising the steps of:
pressing a finger against said concave region;
applying greater pressure on an upper side of said handle between said first razor and said pinnacle than between said pinnacle and said second razor when using said first razor;
applying greater pressure on an upper side of said handle between said second razor and said pinnacle than between said pinnacle and said first razor when using said second razor.

16. The method of claim 15, wherein when applying said greater pressure between said first razor and said pinnacle, moving said razor in a direction more towards said second razor than said first razor.

17. The method of claim 16, wherein when applying said greater pressure between said second razor and said pinnacle, moving said razor in a direction more towards said first razor than said second razor.

18. The method of claim 17, comprising a step of repeating shaving strokes with said double sided razor in a back and forth motion, alternating between placing said greater pressure on one side of said device, then on another side of said device at the same frequency as said alternating.

19. The method of claim 18, wherein said finger in said concave region is used to pivot said razor between said back and said forth motion.
